(19) United States
(12) Patent Application Publication
(10) Pub. No.: US 2014/0235444 A1
(43) Pub. Date: Aug. 21, 2014

(54) SYNERGISTIC SUPRESSION OF GRASS SEEDHEAD PRODUCTION FROM APPLICATIONS OF AMINOCYCLOPYRACHLOR AND METSULFURON

(71) Applicant: Dow AgroSciences LLC, Indianapolis, IN (US)

(72) Inventors: Patrick L. Burch, Christainburg, VA (US); Louise A. Brinkworth, Bedfordshire (GB); Mary B. Halstvedt, Billings, MT (US)

(73) Assignee: Dow AgroSciences LLC, Indianapolis, IN (US)

(21) Appl. No.: 14/172,201

(22) Filed: Feb. 4, 2014

Related U.S. Application Data
(60) Provisional application No. 61/766,371, filed on Feb. 19, 2013.

(51) Int. Cl. A01N 43/66; A01N 43/54

(52) U.S. Cl. CPC A01N 43/66; A01N 43/54
USPC 504/134

(57) ABSTRACT

Disclosed herein are herbicidal compositions comprising a synergistically effective amount for preventing or suppressing grass seedhead production of (a) aminocyclopyrachlor, or an agriculturally acceptable salt or ester thereof, and (b) metsulfuron, or an agriculturally acceptable salt or ester thereof. Also disclosed herein are methods of preventing or suppressing grass seedhead production, which comprise applying to vegetation or an area adjacent the vegetation or applying to soil or water to prevent or suppress grass seedhead production (a) aminocyclopyrachlor, or an agriculturally acceptable salt or ester thereof, and (b) metsulfuron, or an agriculturally acceptable salt or ester thereof, wherein (a) and (b) are each added in an amount sufficient to produce a synergistic grass seedhead-suppressant effect.

### CROSS REFERENCE TO RELATED APPLICATIONS

This application claims the benefit of priority to U.S. Provisional Patent Application No. 61/766,371 filed Feb. 19, 2013, the disclosure of which is expressly incorporated herein by reference in its entirety.

### FIELD OF THE DISCLOSURE

The present disclosure relates to herbicidal compositions comprising a synergistically effective amount to suppress grass seedhead production of (a) aminocyclopyrachloror an agriculturally acceptable salt or ester thereof, and (b) metsulfuron or an agriculturally acceptable salt or ester thereof. The present disclosure also relates to methods for suppressing grass seedhead production, for instance, in fescue.

### BACKGROUND

It is known that grass seedheads (for instance, in tall fescue) contain ergovaline endophytes, which can cause toxicosis leading to accelerated body weight loss, reduced milk production in cows and lower birth weight of calves. To help control undesirable seedhead production, researchers have produced a variety of chemicals and chemical formulations effective in controlling such unwanted seedhead production. However, a continuing need exists for new compositions and methods to suppress seedhead production.

### SUMMARY OF THE DISCLOSURE

Herbicides of many types have been disclosed in the literature and a number are in commercial use. In some cases, herbicidal active ingredients have been found more effective in combination than when applied individually and this is referred to as “synergy” or “synergism.” The present disclosure is based on the discovery that (a) aminocyclopyrachlor, or an agriculturally acceptable salt or ester thereof, and (b) metsulfuron, or an agriculturally acceptable salt or ester thereof, display a synergistic herbicidal effect on preventing or suppressing seedhead production when applied in combination.

Accordingly, the present disclosure relates to herbicidal compositions comprising a synergistically effective amount of (a) aminocyclopyrachlor, or an agriculturally acceptable salt or ester thereof, and (b) metsulfuron, or an agriculturally acceptable salt or ester thereof. In some embodiments, (a) includes aminocyclopyrachlor in acid form. In some embodiments, (b) includes metsulfuron-methyl. The acid equivalent weight ratio of (a) to (b) can be from 1:1 to 12:1 (e.g., from 2:1 to 8:1). In some embodiments, the composition further comprises an additional pesticide (e.g., 2,4-D, amicarbazone, aminopyralid, bromoxynil, chlorsulfuron, clopyralid, dicamba, dichlorprop-P, diclosulam, diuron, florasulam, flucarbazone-sodium, flumetsulam, fluoroxypyr, glyphosate, glufosinate, imazamox, imazapyr, imazapic, imazaquin, imazethapyr, imazamethabenz, indaziflam, ioxynil, MCPA, mecoprop-P, oxyfluorfen, penoxsulam, picloram, pinoxaden, pyroxsulam, rimsulfuron, sulfometuron, thifensulfuron-methyl, tebuthiuron, tribenuron-methyl, triclopyr, or agriculturally acceptable salts or esters or mixtures thereof). The additional pesticide can include 2,4-D choline salt, aminopyralid choline salt, triclopyr choline salt, or a mixture thereof.

The present disclosure also relates to methods of preventing or suppressing grass seedhead production, which comprise applying to vegetation or an area adjacent the vegetation or applying to soil or water to suppress grass seedhead production (a) aminocyclopyrachlor, or an agriculturally acceptable salt or ester thereof and (b) metsulfuron, or an agriculturally acceptable salt or ester thereof, wherein (a) and (b) are each added in an amount sufficient to produce a synergistic grass seedhead-suppressant effect. In some embodiments, (a) and (b) are applied simultaneously. The grass seedhead production can be controlled in grasses tolerant to glyphosate, glufosinate, dicamba, phenoxy auxins, pyridyloxy auxins, aryloxyphenoxypropionates, acetyl CoA carboxylase (ACCase) inhibitors, imidazolinone, acetolactate synthase (ALS) inhibitors, 4-hydroxyphenyl-pyruvate dioxygenase (HPPD) inhibitors, protoporphyrinogen oxidase (PPO) inhibitors, triazines, bromoxynil, or combinations thereof. For example, the grass seedhead production can be controlled in phenoxy auxin tolerant grasses and the phenoxy auxin tolerant grasses have tolerance conferred by an AAD12 gene. In some embodiments, the grass is resistant to auxinic herbicides. In some embodiments, (a) and (b) are applied pre-seedhead emergence to vegetation, such as grasses like fescue. In some embodiments, (a) is applied in an amount of from 5-280 grams acid equivalent per hectare (g ae/ha). In some embodiments, (b) is applied in an amount of from 5-88 g ae/ha.

The description below sets forth details of one or more embodiments of the present disclosure. Other features, objects, and advantages will be apparent from the description and from the claims.

### DETAILED DESCRIPTION

The present disclosure relates to herbicidal compositions comprising a synergistically effective amount to suppress grass seedhead production in of (a) aminocyclopyrachloror an agriculturally acceptable salt or ester thereof, and (b) metsulfuron or an agriculturally acceptable salt or ester thereof. The present disclosure also relates to methods for suppressing grass seedhead production, for instance, in fescue.

The term “herbicide,” as used herein, means an active ingredient that kills, controls, or otherwise adversely modifies the growth of vegetation. A “herbicidally effective amount” is an amount of an active ingredient that causes a “herbicidal effect,” i.e., an adversely modifying effect and includes deviations from, for instance, natural development, killing, regulation, desiccation, and retardation. In some embodiments, the herbicidal effect is the prevention or suppression of grass seedhead production. The terms “plants” and “vegetation” can include, for instance, germinant seeds, emerging seedlings, and established vegetation.

Aminocyclopyrachlor

Compositions and methods of the present disclosure can include aminocyclopyrachlor or an agriculturally acceptable salt or ester thereof. Aminocyclopyrachlor, shown below, is a herbicide that can be used to control broadleaf weeds in, for instance, lawns (e.g., residential, industrial, and institutional), golf courses, parks, cemeteries, athletic fields, sod farms, range and pasture, industrial vegetation management (IVM), rights-of-way, roadsides, railroads, and other crop and non-crop uses. Its herbicidal activity is described in Tomlin, C. D. S., Ed. The Pesticide Manual: A World Compendium, 15^{th} ed.; BCPC: Alton, 2009 (hereafter “The Pesticide Manual, Fifteenth Edition, 2009”).

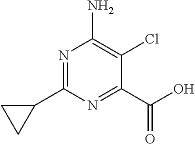 [SMILES: Nc1nc(C2CC2)nc(C(=O)O)c1Cl]

In some embodiments, the aminocyclopyrachlor is in acid form and is 6-amino-5-chloro-2-cyclopropylpyrimidine-4-carboxylic acid (6-amino-5-chloro-2-cyclopropyl-4-pyrimidinecarboxylic acid). In some embodiments, the aminocyclopyrachlor is in the form of an agriculturally acceptable salt or ester thereof. Exemplary agriculturally acceptable salts or esters of aminocyclopyrachlor include, but are not limited to, sodium salts, potassium salts, ammonium salts or substituted ammonium salts (e.g., mono-, di- and tri-C₁-C₈-alkylammonium salts such as methyl ammonium, dimethylammonium and isopropylammonium, mono-, di- and tri-hydroxy-C₂-C₈-alkylammonium salts such as hydroxyethylammonium, di(hydroxyethyl)ammonium, tri(hydroxyethyl)ammonium, hydroxypropylammonium, di(hydroxypropyl)ammonium and tri(hydroxypropyl)ammonium salts), and their diglycolamine salts and their esters (e.g., its C₁-C₈-alkyl esters and C₁-C₄-alkoxy-C₂-C₄-alkyl esters, such as methyl esters, ethyl esters, isopropyl, butyl, hexyl, heptyl, isoheptyl, isooctyl, 2-ethylhexyl and butoxyethyl esters, and aryl esters such as benzyl). Exemplary agriculturally acceptable salts of aminocyclopyrachlor can include aminocyclopyrachlor-sodium, aminocyclopyrachlor-potassium, aminocyclopyrachlor choline salt, or mixtures thereof. An exemplary agriculturally acceptable ester of aminocyclopyrachlor can include aminocyclopyrachlor-methyl. Aminocyclopyrachloror agriculturally acceptable salts or esters thereof are or have been commercially available, for example, from DUPONT CROP PROTECTION under the trademarks IMPRELIS®, REJUVRA®, STREAMLINE®, VIEWPOINT®, METHOD®, and PLAINVIEW®.

The aminocyclopyrachloror an agriculturally acceptable salt or ester thereof can be applied to vegetation or an area adjacent the vegetation or applied to soil or water to prevent or suppress seedhead production in, for instance, grasses such as fescue. In some embodiments, the aminocyclopyrachloror agriculturally acceptable salt or ester thereof is applied to vegetation or an area adjacent the vegetation or applied to soil or water to prevent or suppress seedhead production in an amount of 5 grams acid equivalent per hectare (g ae/ha) or greater (e.g., 10 g ae/ha or greater, 15 g ae/ha or greater, 20 g ae/ha or greater, 25 g ae/ha or greater, 30 g ae/ha or greater, 35 g ae/ha or greater, 40 g ae/ha or greater, 45 g ae/ha or greater, 50 g ae/ha or greater, 55 g ae/ha or greater, 60 g ae/ha or greater, 65 g ae/ha or greater, 70 g ae/ha or greater, 75 g ae/ha or greater, 80 g ae/ha or greater, 85 g ae/ha or greater, 90 g ae/ha or greater, 95 g ae/ha or greater, 100 g ae/ha or greater, 105 g ae/ha or greater, 110 g ae/ha or greater, 115 g ae/ha or greater, 120 g ae/ha or greater, 140 g ae/ha or greater, 160 g ae/ha or greater, 180 g ae/ha or greater, 200 g ae/ha or greater, 220 g ae/ha or greater, 240 g ae/ha or greater, or 260 g ae/ha or greater). In some embodiments, the aminocyclopyrachloror agriculturally acceptable salt or ester thereof is applied to vegetation or an area adjacent the vegetation or applied to soil or water to prevent or suppress seedhead formation in an amount of 280 g ae/ha or less (e.g., 270 g ae/ha or less, 260 g ae/ha or less, 250 g ae/ha or less, 240 g ae/ha or less, 230 g ae/ha or less, 220 g ae/ha or less, 210 g ae/ha or less, 200 g ae/ha or less, 190 g ae/ha or less, 180 g ae/ha or less, 170 g ae/ha or less, 160 g ae/ha or less, 150 g ae/ha or less, 140 g ae/ha or less, 130 g ae/ha or less, 120 g ae/ha or less, 110 g ae/ha or less, 100 g ae/ha or less, 90 g ae/ha or less, 80 g ae/ha or less, 70 g ae/ha or less, 60 g ae/ha or less, 50 g ae/ha or less, 40 g ae/ha or less, 30 g ae/ha or less, 25 g ae/ha or less, 20 g ae/ha or less, 15 g ae/ha or less, or 10 g ae/ha or less). In some embodiments, the aminocyclopyrachloror agriculturally acceptable salt or ester thereof is applied to vegetation or an area adjacent the vegetation or applied to soil or water to prevent the emergence or growth of vegetation in an amount of from 5-280 g ae/ha (e.g., from 16-220 g ae/ha, from 35-210 g ae/ha, from 50-180 g ae/ha, from 60-160 g ae/ha, or from 70-140 g ae/ha).

Metsulfuron

Compositions and methods of the present disclosure can include metsulfuron or an agriculturally acceptable salt or ester thereof. Metsulfuron-methyl, shown below, is a herbicide that can be used to control, for instance, most broadleaf weeds and some annual grass weeds in barley, wheat, fallow land, pastures, rangeland, and noncropland. Its herbicidal activity is described in THE PESTICIDE MANUAL, Fifteenth Edition, 2009.

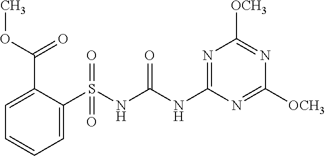 [SMILES: COC(=O)c1ccccc1S(=O)(=O)NC(=O)Nc1nc(OC)nc(OC)n1]

Metsulfuron can be provided in its acid form, or as an agriculturally acceptable salt or ester thereof. Exemplary agriculturally acceptable salts or esters of metsulfuron include, but are not limited to, sodium salts, potassium salts, ammonium salts or substituted ammonium salts, in particular mono-, di- and tri-C₁-C₈-alkylammonium salts such as methyl ammonium, dimethylammonium and isopropylammonium (e.g., triisopropanolammonium), mono-, di- and tri-hydroxy-C₂-C₈-alkylammonium salts such as hydroxyethylammonium, di(hydroxyethyl)ammonium, tri(hydroxyethyl)ammonium, hydroxypropylammonium, di(hydroxypropyl)ammonium and tri(hydroxypropyl)ammonium salts, their diglycolamine salts and their esters, in particular its C₁-C₈-alkyl esters and C₁-C₄-alkoxy-C₂-C₄-alkyl esters, such as methyl esters, ethyl esters, isopropyl, butyl, hexyl, heptyl, isoheptyl, isooctyl, 2-ethylhexyl and butoxyethyl esters. Exemplary agriculturally acceptable salts or esters of metsulfuron can include, but are not limited to, the ethyl, iso-propyl, butyl, iso-butyl, iso-octyl, 2-ethylhexyl, and 2-butoxyethyl esters of metsulfuron, and the sodium, iso-propylammonium, dimethylammonium, diethanolammonium, di-iso-propylammonium, triethanolammonium, tri-iso-propylammonium, tri-iso-propanolammonium, and choline salts of metsulfuron, and mixtures thereof. In some embodiments, the metsulfuron is provided as an amine salt, such as metsulfuron-olamine salt, dimethylamine (DMA) salt, monoethanolamine (MEA) salt, triisopropanolamine (TIPA) salt, or a mixture thereof. In some embodiments, metsulfuron is provided as metsulfuron-methyl ester. Metsulfuron and agriculturally acceptable salts or esters thereof are or have been commercially available, for example, under the trademarks: ASSET®, AVAIL® XT, METRO 20® (by AGRIGUARD LTD.); ACCURATE® (by CHEMINOVA A/S); ALLIE®, ALY® with TOTALSOL®, ESCORT® XP (by DUPONT CROP PROTECTION); QUIT®, REFARM® (by HUBEI SANONDA CO., LTD.); WEED GRIP® (by INSECTICIDES (INDIA) LTD.); MALBAN® (by IPESA S.A.); METGUARD®, NICANOR®, ROZAR®, VALURON® (by MAKHTESHIM AGAN GROUP); MANOR®, PATRIOT® (by Nufarm Ams Inc.); PILARSCORT (by PILAR AGRISCIENCE (CANADA) CORP.); METSULINDO® (by PT. Inti Everspring Indonesia); ROSULFURON® (by ROTAM CROPSCIENCES, INC.); PARTI-SAN® (by SANONDA (AUSTRALIA) PTY. LTD.); METRO 20®, METSUL® (by SULPHUR MILLS LTD.); METSY® (by UNITED PHOSPHORUS LTD.); METHOD® (by WANGS CROP-SCIENCE CO., LTD.); and ELIKE® (by ZAGRO SINGAPORE PTE. LTD.).

The metsulfuron or an agriculturally acceptable salt or ester thereof described herein can be used in an amount sufficient to produce a synergistic grass seedhead-suppressant effect. In some embodiments, the metsulfuron or agriculturally acceptable salt or ester thereof is applied to vegetation or an area adjacent the vegetation or applied to soil or water to prevent or suppress grass seedhead production in an amount of 5 grams acid equivalent per hectare (g ae/ha) or greater (e.g., 10 g ae/ha or greater, 15 g ae/ha or greater, 20 g ae/ha or greater, 25 g ae/ha or greater, 30 g ae/ha or greater, 35 g ae/ha or greater, 40 g ae/ha or greater, 45 g ae/ha or greater, 50 g ae/ha or greater, 55 g ae/ha or greater, 60 g ae/ha or greater, 65 g ae/ha or greater, 70 g ae/ha or greater, 75 g ae/ha or greater, or 80 g ae/ha or greater). In some embodiments, the metsulfuron or agriculturally acceptable salt or ester thereof is applied to vegetation or an area adjacent the vegetation or applied to soil or water to prevent or suppress seedhead production in an amount of 88 g ae/ha or less (e.g., 85 g ae/ha or less, 80 g ae/ha or less, 75 g ae/ha or less, 70 g ae/ha or less, 65 g ae/ha or less, 60 g ae/ha or less, 55 g ae/ha or less, 50 g ae/ha or less, 45 g ae/ha or less, 40 g ae/ha or less, 35 g ae/ha or less, 30 g ae/ha or less, 25 g ae/ha or less, 20 g ae/ha or less, 15 g ae/ha or less, or 10 g ae/ha or less). In some embodiments, the metsulfuron or agriculturally acceptable salt or ester thereof is applied to vegetation or an area adjacent the vegetation or applied to soil or water to prevent or suppress seedhead production in an amount of from 5-88 g ae/ha (e.g., from 10-85 g ae/ha, from 15-80 g ae/ha, from 20-75 g ae/ha, from 25-70 g ae/ha, from 30-65 g ae/ha, from 35-60 g ae/ha, or from 40-55 g ae/ha).

Herbicidal Mixtures or Combinations

The (a) aminocyclopyrachloror an agriculturally acceptable salt or ester thereof is mixed with or applied in combination with (b) metsulfuron or an agriculturally acceptable salt or ester thereof in an amount sufficient to produce a synergistic grass seedhead-suppressant effect. In some embodiments, (a) and (b) are used in an amount sufficient to produce a synergistic grass seedhead-suppressant effect while still showing good grass compatibility (i.e. their use in grasses does not result in increased damage to the grass leaves, for instance, when compared to the individual application of the herbicidal compounds (a) or (b)). As described in the Herbicide Handbook of the Weed Science Society of America, Ninth Edition, 2007, p. 429, “‘synergism’ [is] an interaction of two or more factors such that the effect when combined is greater than the predicted effect based on the response to each factor applied separately.” Synergistic in the herbicide context can mean that the use of (a) and (b) as defined above results in increased suppression or prevention of seedhead production compared to the suppression or prevention of seedhead production that are possible with the use of (a) or (b) alone. In some embodiments, the prevention or suppression of seedhead production caused by the compositions and methods disclosed herein is evaluated using a scale from 0% to 100%, when compared with the untreated control grass, wherein 0% indicates prevention or suppression of seedhead production and 100% indicates complete prevention or suppression of seedhead production. In some embodiments, Colby's formula is applied to determine whether using (a) and (b) in combination shows a synergistic effect: S. R. Colby, Calculating Synergistic and Antagonistic Responses of Herbicide Combinations, WEEDS 15, p. 22 (1967),

$$E = X + Y - \frac{X * Y}{100}$$

wherein

X=effect in percent using (a) aminocyclopyrachloror an agriculturally acceptable salt or ester thereof at an application rate a;

Y=effect in percent using (b) metsulfuron or an agriculturally acceptable salt or ester thereof at an application rate b;

E=expected effect (in percent, %) of (a)+(b) at application rates a and b.

In Colby's equation, the value E corresponds to the effect (prevention or suppression of seedhead production) that is to be expected if the activity of the individual compounds is additive. If the observed effect is higher than the value E calculated according to the Colby equation, then a synergistic effect is present according to the Colby equation.

In some embodiments, the compositions and methods disclosed herein are synergistic as defined by the Colby equation. In some embodiments, the joint action of aminocyclopyrachlor or an agriculturally acceptable salt or ester thereof and metsulfuron or an agriculturally acceptable salt or ester thereof results in enhanced prevention or suppression of seedhead production (via synergism), even at application rates below those typically used for the pesticide to have a herbicidal effect on its own. In some embodiments, the compositions and methods disclosed herein can, based on the individual components, be used at lower application rates to achieve a herbicidal effect comparable to the effect produced by the individual components at normal application rates. In some embodiments, the compositions and methods disclosed herein provide an accelerated action of preventing or suppressing grass seedhead production (i.e. they prevent or suppress grass seedhead production more quickly compared with application of the individual herbicides).

In some embodiments, the acid equivalent weight ratio of (a) aminocyclopyrachloror agriculturally acceptable salt or ester thereof to (b) metsulfuron or an agriculturally acceptable salt or ester thereof that is sufficient to induce a synergistic grass seedhead-suppressant effect is at least 1:1 (e.g., at least 1.25:1, at least 1.5:1, at least 1.75:1, at least 2:1, at least 2.25:1, at least 2.5:1, at least 2.75:1, at least 3:1, at least 3.25:1, at least 3.5:1, at least 3.75:1, at least 4:1, at least 5:1, at least 6:1, at least 7:1, at least 8:1, at least 9:1, at least 10:1, or at least 11:1). In some embodiments, the acid equivalent weight ratio of (a) to (b) that is sufficient to induce a synergistic grass seedhead-suppressant effect is 12:1 or less (e.g., 11:1 or less, 10:1 or less, 9:1 or less, 8:1 or less, 7:1 or less, 6:1 or less, 5:1 or less, 4:1 or less, 3:75 or less, 3.5:1 or less, 3.25:1 or less, 3:1 or less, 2.75:1 or less, 2.5:1 or less, 2.25:1 or less, 2:1 or less, 1.75:1 or less, 1.5:1 or less, or 1.25:1 or less). In some embodiments, the acid equivalent weight ratio of (a) to (b) is from 1:1 to 12:1 (e.g., from 1.5:1 to 11:1, from 1.75:1 to 9:1, from 2:1 to 8:1, from 3:1 to 7:1, or from 4:1 to 6:1). In some embodiments, the acid equivalent weight ratio of (a) to (b) is from 4:1 to 8:1.

Formulations

The present disclosure also relates to formulations of the compositions and methods disclosed herein. In some embodiments, the formulation can be in the form of a single package formulation including both (a) aminocyclopyrachloror an agriculturally acceptable salt or ester thereof and (b) metsulfuron or an agriculturally acceptable salt or ester thereof. In some embodiments, the formulation can be in the form of a single package formulation including both (a) and (b) and further including at least one additive. In some embodiments, the formulation can be in the form of a two-package formulation, wherein one package contains (a) and optionally at least one additive while the other package contains (b) and optionally at least one additive. In some embodiments of the two-package formulation, the formulation including (a) and optionally at least one additive and the formulation including (b) and optionally at least one additive are mixed before application and then applied simultaneously. In some embodiments, the mixing is performed as a tank mix (i.e., the formulations are mixed immediately before or upon dilution with water). In some embodiments, the formulation including (a) and the formulation including (b) are not mixed but are applied sequentially (in succession), for example, immediately or within 1 hour, within 2 hours, within 4 hours, within 8 hours, within 16 hours, within 24 hours, within 2 days, or within 3 days, of each other.

In some embodiments, the formulation of (a) and (b) is present in suspended, emulsified, or dissolved form. Exemplary formulations include, but are not limited to, aqueous solutions, powders, suspensions, also highly-concentrated aqueous, oily or other suspensions or dispersions, aqueous emulsions, aqueous microemulsions, aqueous suspo-emulsions, oil dispersions, pastes, dusts, and materials for spreading or granules.

In some embodiments, (a) aminocyclopyrachloror an agriculturally acceptable salt or ester thereof and/or (b) metsulfuron or an agriculturally acceptable salt or ester thereof is an aqueous solution that can be diluted before use. In some embodiments, (a) and/or (b) is provided as a high-strength formulation such as a concentrate. In some embodiments, the concentrate is stable and retains potency during storage and shipping. In some embodiments, the concentrate is a clear, homogeneous liquid that is stable at temperatures of 54° C. or greater. In some embodiments, the concentrate does not exhibit any precipitation of solids at temperatures of −10° C. or higher. In some embodiments, the concentrate does not exhibit separation, precipitation, or crystallization of any components at low temperatures. For example, the concentrate remains a clear solution at temperatures below 0° C. (e.g., below −5° C., below −10° C., below −15° C.). In some embodiments, the concentrate exhibits a viscosity of less than 50 centipoise (50 megapascals), even at temperatures as low as 5° C.

The compositions and methods disclosed herein can also be mixed with or applied with an additive. In some embodiments, the additive can be diluted in water or can be concentrated. In some embodiments, the additive is added sequentially. In some embodiments, the additive is added simultaneously. In some embodiments, the additive is premixed with the aminocyclopyrachloror agriculturally acceptable salt or ester thereof. In some embodiments, the additive is premixed with the metsulfuron or agriculturally acceptable salt or ester thereof. In some embodiments, the additive is premixed with the aminocyclopyrachloror agriculturally acceptable salt or ester and the metsulfuron or agriculturally acceptable salt or ester thereof.

In some embodiments, the additive is an additional pesticide. Exemplary additional pesticides include, but are not limited to, 2,4-D, acetochlor, aclonifen, amicarbazone, 4-aminopicolinic acid based herbicides, such as halauxifen, halauxifen-methyl, and those described in U.S. Pat. Nos. 7,314,849 (B2) and 7,432,227 (B2), ametryn, amidosulfuron, aminopyralid, aminotriazole, ammonium thiocyanate, asulam, anilofos, atrazine, beflubutamid, benazolin, bentazone, bifenox, bromacil, bromoxynil, butachlor, butafenacil, butralin, butroxydim, carbetamide, carfentrazone, carfentrazone-ethyl, chlormequat, chlorsulfuron, chlortoluron, cinidon-ethyl, clethodim, clodinafop-propargyl, clomazone, cyanazine, cyclosulfamuron, cycloxydim, dicamba, dichlobenil, dichlorprop, dichlorprop-P, diclofop-methyl, diclosulam, diflufenican, diflufenzopyr, dimefuron, dimethachlor, diquat, diuron, EPTC, ethoxysulfuron, fenoxaprop, fenoxaprop-ethyl, fenoxaprop-ethyl+isoxadifen-ethyl, fenoxaprop-P-ethyl, fenoxasulfone, flazasulfuron, florasulam, fluazifop, fluazifop-P-butyl, flucarbazone, flucarbazone-sodium, flucetosulfuron (LGC-42153), flufenacet, flumetsulam, flumioxazin, flupyrsulfuron, fluoroxypyr, fluoroxypyr-meptyl, flurtamone, gibberellic acid, glufosinate, glufosinate-ammonium, glyphosate, haloxyfop-methyl, haloxyfop-R, hexazinone, imazamethabenz, imazamox, imazapic, imazapyr, imazaquin, imazethapyr, imazosulfuron, indanofan, indaziflam, iodosulfuron, iodosulfuron-ethyl-sodium, ioxynil, isoproturon, isoxaben, isoxaflutole, lactofen, linuron, MCPA, MCPB, mecoprop, mecoprop-P, mesosulfuron, mesosulfuron-ethyl sodium, metazochlor, metosulam, metribuzin, metsulfuron, metsulfuron-methyl, MSMA, 1-napthaleneacetic acid, napropamide, norfurazon, orthosulfamuron, oryzalin, oxadiargyl, oxadiazon, oxyfluorfen, paraquat, pendimethalin, penoxsulam, picloram, picolinafen, pinoxaden, piperophos, primisulfuron, profluazol, prometon, propanil, propaquizafop, propoxycarbazone, propyzamide, prosulfocarb, prosulfuron, pyraflufen-ethyl, pyrasulfotole, pyribenzoxim (LGC-40863), pyroxsulam, pyroxasulfone, quinclorac, quinmerac, quizalofop-ethyl-D, quizalofop-P-ethyl, quizalofop-P-tefuryl, rimsulfuron, sethoxydim, simazine, sulfentrazone, sulfometuron, sulfosate, sulfosulfuron, tebuthiuron, tepraloxidim, terbacil, terbutryn, thiazopyr, thiencarbazone-methyl, thifensulfuron, thifensulfuron-methyl, topramezone, tralkoxydim, triasulfuron, tribenuron, tribenuron-methyl, triafamone, triclopyr, and trifluralin, and agriculturally acceptable salts, esters, and mixtures thereof. In some embodiments, the additional pesticide includes 2,4-D choline salt, aminopyralid choline salt, triclopyr choline salt, or a mixture thereof.

In some embodiments, the aminocyclopyrachloror an agriculturally acceptable salt or ester thereof is provided in a premixed formulation with an additional pesticide. In some embodiments, the aminocyclopyrachloror an agriculturally acceptable salt or ester thereof is premixed with, chlorsulfuron, dicamba, imazapyr, glufosinate, glyphosate, MCPA, metsulfuron-methyl, or mixtures thereof. Exemplary premixes of aminocyclopyrachloror an agriculturally acceptable salt or ester thereof and an additive that are or have been commercially available include, but are not limited to, PERSPECTIVE® (a premix incorporating chlorsulfuron by DUPONT CROP PROTECTION), VIEWPOINT® (a premix incorporating imazapyr and metsulfuron-methyl by DUPONT CROP PROTECTION), PLAINVIEW® (a premix incorporating sulfometuron and chlorsulfuron by DUPONT CROP PROTECTION), or STREAMLINE® (a premix incorporating metsulfuron-methyl by DUPONT CROP PROTECTION).

In some embodiments, the metsulfuron or an agriculturally acceptable salt or ester thereof is provided in a premixed formulation with an additional pesticide. In some embodiments, the metsulfuron or an agriculturally acceptable salt or ester thereof is premixed with acetochlor, aminocyclopyrachlor, imazapyr, aminopyralid, carfentrazone-ethyl, chlorimuron-ethyl, chlorsulfuron, 2,4-D, dicamba, thifensulfuron-methyl, tribenuron-methyl, fluoroxypyr, glyphosate, nicosulfuron, picloram, propanil, pyraflufen-ethyl, sulfentrazone, sulfometuron-methyl, sulfosulfuron, thifensulfuron-methyl, tribenuron-methyl, triclopyr, or mixtures thereof. Exemplary premixes of metsulfuron or an agriculturally acceptable salt or ester thereof and an additive that are or have been commercially available include, but are not limited to: MIECAOBAO® (a premix incorporating acetochlor); STREAMLINE® (a premix incorporating aminocyclopyrachlor by DOW AGROSCIENCES, LLC); VIEWPOINT® (a premix incorporating aminocyclopyrachlor and imazapyr by DOW AGROSCIENCES, LLC); CHAPARRAL®, CLEARVIEW® (premixes incorporating aminopyralid by DOW AGROSCIENCES, LLC.); ASSET® EXPRESS, AL-VIDA® (premixes incorporating chlorimuron-ethyl by M/S HPM CHEMS. & FERTILIZERS LTD.); CHISUM®, REPORT® EXTRA (premixes incorporating chlorsulfuron by CHEMINOVA, INC.); CIMARRON® PLUS, CIMARRON® EXTRA, FINESS® CEREAL & FALLOW (premixes incorporating chlorsulfuron by DUPONT CROP PROTECTION); MATAMONTE® (a premix incorporating 2,4-D by DUPOCSA, PROTECTORES QUIMICOS PARA EL CAMPO S.A.); CIMARRON® MAX (a premix incorporating 2,4-D and dicamba by DUPONT CROP PROTECTION); AGILITY® SG with TOTALSOL® (a premix incorporating dicamba, thifensulfuron-methyl, and tribenuron-methyl by DUPONT CROP PROTECTION); CROUPIER® (a premix incorporating fluoroxypyr by AGRIGUARd LTD.); GRAND SWEEPER® (a premix incorporating glyphosate by AGRODRAGON CO. LTD.); LINEAGE® CLEARSTAND® (a premix incorporating imazapyr by DUPONT CROP PROTECTION); PASTORA® (a premix incorporating nicosulfuron by DUPONT CROP PROTECTION); KAPUT® (a premix incorporating picloram by INSECTICIDAS INTERNACIONALES, C.A.); SOClO® (a premix incorporating picloram by INVESA S.A.); PROPALAI® (a premix incorporating propanil by DUPOCSA, PROTECTORES QUIMICOS PARA EL CAMPO S.A.); SULFONIL® (a premix incorporating propanil); CALIENTE® (a premix incorporating pyraflufen-ethyl by SEPRO CORP.); BLINDSIDE® (a premix incorporating sulfentrazone by FMC CORP.); OUST® EXTRA (a premix incorporating sulfometuron-methyl by DUPONT CROP PROTECTION); SPYDER® EXTRA (a premix incorporating sulfometuron-methyl by NUFARM AMS. INC.); ACCURATE® EXTRA (a premix incorporating thifensulfuron-methyl and tribenuron-methyl by CHEMINOVA, INC.); ALLY® EXTRA SG with TOTALSOL® (a premix incorporating thifensulfuron-methyl and tribenuron-methyl by DUPONT CROP PROTECTION); and ULTIMATE® (a premix incorporating triclopyr from ZELAM LTD.).

In some embodiments, the additive includes an agriculturally acceptable adjuvant. Exemplary agriculturally acceptable adjuvants include, but are not limited to, antifreeze agents, antifoam agents, compatibilizing agents, sequestering agents, neutralizing agents and buffers, corrosion inhibitors, colorants, odorants, penetration aids, wetting agents, spreading agents, dispersing agents, thickening agents, freeze point depressants, antimicrobial agents, crop oil, safeners, adhesives (for instance, for use in seed formulations), surfactants, protective colloids, emulsifiers, tackifiers, and mixtures thereof. Exemplary agriculturally acceptable adjuvants include, but are not limited to, crop oil concentrate (mineral oil (85%)+emulsifiers (15%)); nonylphenol ethoxylate; benzylcocoalkyldimethyl quaternary ammonium salt; blend of petroleum hydrocarbon, alkyl esters, organic acid, and anionic surfactant; C₉-C₁₁ alkylpolyglycoside; phosphate alcohol ethoxylate; natural primary alcohol (C₁₂-C₁₆) ethoxylate; di-sec-butylphenol EO-PO block copolymer; polysiloxane-methyl cap; nonylphenol ethoxylate+urea ammonium nitrate; emulsified methylated seed oil; tridecyl alcohol (synthetic) ethoxylate (8 EO); tallow amine ethoxylate (15 EO); and PEG(400) dioleate-99.

In some embodiments, the additive is a safener that is an organic compound leading to better plant compatibility when applied with a herbicide. In some embodiments, the safener itself is herbicidally active. In some, the safener acts as an antidote or antagonist in the grasses and can reduce or prevent damage to the grasses. Exemplary safeners include, but are not limited to, AD-67 (MON 4660), benoxacor, benthiocarb, brassinolide, cloquintocet (mexyl), cyometrinil, cyprosulfamide, daimuron, dichlormid, dicyclonon, dietholate, dimepiperate, disulfoton, fenchlorazole, fenchlorazole-ethyl, fenclorim, flurazole, fluxofenim, furilazole, harpin proteins, isoxadifen-ethyl, jiecaowan, jiecaoxi, mefenpyr, mefenpyr-diethyl, mephenate, naphthalic anhydride, 2,2,5-trimethyl-3-(dichloroacetyl)-1,3-oxazolidine, 4-(dichloroacetyl)-1-oxa-4-azaspiro[4.5]decane, oxabetrinil, 829148, and N-phenyl-sulfonylbenzoic acid amides, as well as agriculturally acceptable salts and, provided they have a carboxyl group, their agriculturally acceptable derivatives thereof. In some embodiments, the safener can be cloquintocet or an ester or salt thereof, such as cloquintocet (mexyl).

Exemplary surfactants (e.g., wetting agents, tackifiers, dispersants, emulsifiers) include, but are not limited to, the alkali metal salts, alkaline earth metal salts and ammonium salts of aromatic sulfonic acids, for example lignosulfonic acids, phenolsulfonic acids, naphthalenesulfonic acids, and dibutylnaphthalenesulfonic acid, and of fatty acids, alkyl- and alkylarylsulfonates, alkyl sulfates, lauryl ether sulfates and fatty alcohol sulfates, and salts of sulfated hexa-, hepta- and octadecanols, and also of fatty alcohol glycol ethers, condensates of sulfonated naphthalene and its derivatives with formaldehyde, condensates of naphthalene or of the naphthalene sulfonic acids with phenol and formaldehyde, polyoxyethylene octylphenol ether, ethoxylated isooctyl-, octyl- or nonylphenol, alkylphenyl or tributylphenyl polyglycol ether, alkyl aryl polyether alcohols, isotridecyl alcohol, fatty alcohol/ethylene oxide condensates, ethoxylated castor oil, polyoxyethylene alkyl ethers or polyoxypropylene alkyl ethers, lauryl alcohol polyglycol ether acetate, sorbitol esters, lignosulfite waste liquors and proteins, denatured proteins, polysaccharides (e.g., methylcellulose), hydrophobically modified starches, polyvinyl alcohol, polycarboxylates, polyalkoxylates, polyvinyl amine, polyethyleneimine, polyvinylpyrrolidone and copolymers thereof.

Exemplary thickeners include, but are not limited to, polysaccharides, such as xanthan gum, and organic and inorganic sheet minerals, and mixtures thereof.

Exemplary antifoam agents include, but are not limited to, silicone emulsions, long-chain alcohols, fatty acids, salts of fatty acids, organofluorine compounds, and mixtures thereof.

Exemplary antimicrobial agents include, but are not limited to, bactericides based on dichlorophen and benzyl alcohol hemiformal, and isothiazolinone derivates, such as alkylisothiazolinones and benzisothiazolinones, and mixtures thereof.

Exemplary antifreeze agents, include, but are not limited to ethylene glycol, propylene glycol, urea, glycerol, and mixtures thereof.

Exemplary colorants include, but are not limited to, the dyes known under the names Rhodamine B, pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108, and mixtures thereof.

Exemplary adhesives include, but are not limited to, polyvinylpyrrolidone, polyvinyl acetate, polyvinyl alcohol, tylose, and mixtures thereof.

In some embodiments, the additive includes a carrier. In some embodiments, the additive includes a liquid or solid carrier. In some embodiments, the additive includes an organic or inorganic carrier. Exemplary liquid carriers include, but are not limited to, petroleum fractions or hydrocarbons such as mineral oil, aromatic solvents, paraffinic oils, and the like; vegetable oils such as soybean oil, rapeseed oil, olive oil, castor oil, sunflower seed oil, coconut oil, corn oil, cottonseed oil, linseed oil, palm oil, peanut oil, safflower oil, sesame oil, tung oil and the like; esters of the above vegetable oils; esters of monoalcohols or dihydric, trihydric, or other lower polyalcohols (4-6 hydroxy containing), such as 2-ethyl hexyl stearate, n-butyl oleate, isopropyl myristate, propylene glycol dioleate, di-octyl succinate, di-butyl adipate, di-octyl phthalate and the like; esters of mono, di and polycarboxylic acids and the like, toluene, xylene, petroleum naphtha, crop oil, acetone, methyl ethyl ketone, cyclohexanone, trichloroethylene, perchloroethylene, ethyl acetate, amyl acetate, butyl acetate, propylene glycol monomethyl ether and diethylene glycol monomethyl ether, methyl alcohol, ethyl alcohol, isopropyl alcohol, amyl alcohol, ethylene glycol, propylene glycol, glycerine, N-methyl-2-pyrrolidinone, N,N-dialkylamides, dimethyl sulfoxide, liquid fertilizers and the like, and water as well as mixtures thereof. Exemplary solid carriers include, but are not limited to, silicas, silica gels, silicates, talc, kaolin, limestone, lime, chalk, bole, loess, clay, dolomite, diatomaceous earth, calcium sulfate, magnesium sulfate, magnesium oxide, ground synthetic materials, pyrophyllite clay, attapulgus clay, kieselguhr, calcium carbonate, bentonite clay, Fuller's earth, cottonseed hulls, wheat flour, soybean flour, pumice, wood flour, walnut shell flour, lignin, ammonium sulfate, ammonium phosphate, ammonium nitrate, ureas, cereal meal, tree bark meal, wood meal and nutshell meal, cellulose powders, and mixtures thereof.

In some embodiments, emulsions, pastes or oil dispersions, can be prepared by homogenizing (a) and (b) in water by means of wetting agent, tackifier, dispersant or emulsifier. In some embodiments, concentrates suitable for dilution with water are prepared, comprising (a), (b), a wetting agent, a tackifier, and a dispersant or emulsifier.

In some embodiments, powders or materials for spreading and dusts can be prepared by mixing or concomitant grinding of (a) and (b) and optionally a safener with a solid carrier.

In some embodiments, granules (e.g. coated granules, impregnated granules and homogeneous granules) can be prepared by binding the (a) and (b) to solid carriers.

The formulations disclosed herein can comprise a synergistic grass seedhead-suppressant effective amount of (a) and (b). In some embodiments, the concentrations of (a) and (b) in the formulations can be varied. In some embodiments, the formulations comprise from 1% to 95% (e.g., from 5% to 95%, from 10% to 80%, from 20% to 70%, from 30% to 50%) by total weight of (a) and (b). In some embodiments, (a) and (b), independently, can be employed in a purity of from 90% to 100% (e.g., from 95% to 100%) according to nuclear magnetic resonance (NMR) spectrometry. In some embodiments, the concentrations of (a), (b), and additional pesticides in the formulations can be varied. In some embodiments, the formulations comprise from 1% to 95% (e.g., from 5% to 95%, from 10% to 80%, from 20% to 70%, from 30% to 50%) by total weight of (a), (b), and additional pesticides. In some embodiments, (a), (b), and additional pesticides, independently, can be employed in a purity of from 90% to 100% (e.g., from 95% to 100%) according to NMR spectrometry.

Methods of Application

The compositions disclosed herein can be applied in any known technique for applying herbicides. Exemplary application techniques include, but are not limited to, spraying, atomizing, dusting, spreading, or direct application into water (in-water). The method of application can vary depending on the intended purpose. In some embodiments, the method of application can be chosen to ensure the finest possible distribution of the compositions disclosed herein.

The compositions disclosed herein can be applied pre emergence (before the emergence of seedheads) or post-emergence (i.e., during and/or after emergence of seedheads). In some embodiments, the compositions disclosed herein are applied post-emergence when the seedheads start developing. In some embodiments, the compositions disclosed herein are applied post-emergence to immature seedheads to achieve the reduction of seedhead production.

In some embodiments, the compositions disclosed herein are applied to vegetation or an area adjacent the vegetation or applying to soil or water to prevent or reduce seedhead production by spraying (e.g., foliar spraying). In some embodiments, the spraying techniques use, for example, water as carrier and spray liquor rates of from 10 liters per hectare (L/ha) to 2000 L/ha (e.g., from 50 L/ha to 1000 L/ha, or from 100 to 500 L/ha). In some embodiments, the compositions disclosed herein are applied by the low-volume or the ultra-low-volume method, wherein the application is in the form of micro-granules. In some embodiments, wherein the compositions disclosed herein are less well tolerated by certain grasses, the compositions can be applied with the aid of the spray apparatus in such a way that they come into little contact, if any, with the leaves of the sensitive grasses while reaching the seedheads.

In some embodiments, wherein the grasses are treated post-emergence, the compositions disclosed herein are applied by foliar application. In some embodiments, a synergistic grass seedhead-suppressant effect is exhibited by the compounds of the synergistic mixture when they are applied directly to the grass or to the locus of the grass at any stage of growth or before planting or emergence. The effect observed can depend upon the type of seedhead production to be controlled, the stage of growth of the grass, the application parameters of dilution and spray drop size, the particle size of solid components, the environmental conditions at the time of use, the specific compound employed, the specific adjuvants and carriers employed, the soil type, and the like, as well as the amount of chemical applied. In some embodiments, these and other factors can be adjusted to promote non-selective or selective herbicidal action.

The compositions and methods disclosed herein can be used in a variety of grasses, including without limitation, turf, pasture, grasslands, grasses grown for seeds, lawns (e.g., residential, industrial, and institutional), golf courses, parks, cemeteries, athletic fields, and sod farms. In some embodiments, the grass is fescue.

The compositions and methods disclosed herein can also be used in grasses that are resistant to, for instance, herbicides, pathogens, and/or insects. In some embodiments, the compositions and methods disclosed herein can be used in grasses that are resistant to one or more herbicides because of genetic engineering or breeding. In some embodiments, the compositions and methods disclosed herein can be used in grasses that are resistant to one or more pathogens such as plant pathogenous fungi owing to genetic engineering or breeding. In some embodiments, the compositions and methods disclosed herein can be used in grasses that are resistant to attack by insects owing to genetic engineering or breeding. In some embodiments, the compositions and methods disclosed herein, owing to introduction of the gene for Bacillus thuringiensis (or Bt) toxin by genetic modification, are resistant to attack by certain insects. In some embodiments, the compositions and methods described herein also can be used in conjunction with glyphosate, glufosinate, dicamba, phenoxy auxins, pyridyloxy auxins, aryloxyphenoxypropionates, acetyl CoA carboxylase (ACCase) inhibitors, imidazolinones, acetolactate synthase (ALS) inhibitors, 4-hydroxyphenyl-pyruvate dioxygenase (HPPD) inhibitors, protoporphyrinogen oxidase (PPO) inhibitors, triazines, and bromoxynil to control vegetation in grasses tolerant to glyphosate, glufosinate, dicamba, phenoxy auxins, pyridyloxy auxins, aryloxyphenoxypropionates, acetyl CoA carboxylase (ACCase) inhibitors, imidazolinones, acetolactate synthase (ALS) inhibitors, 4-hydroxyphenyl-pyruvate dioxygenase (HPPD) inhibitors, protoporphyrinogen oxidase (PPO) inhibitors, triazines, bromoxynil, or combinations thereof. In some embodiments, the seedhead production is suppressed or prevented in glyphosate, glufosinate, dicamba, phenoxy auxins, pyridyloxy auxins, aryloxyphenoxypropionates, acetyl CoA carboxylase (ACCase) inhibitors, imidazolinones, acetolactate synthase (ALS) inhibitors, 4-hydroxyphenyl-pyruvate dioxygenase (HPPD) inhibitors, protoporphyrinogen oxidase (PPO) inhibitors, triazines, and bromoxynil tolerant grasses possessing multiple or stacked traits conferring tolerance to multiple chemistries and/or multiple modes of action. In some embodiments, the seedhead production is suppressed or prvented in phenoxy auxin tolerant grasses and the phenoxy auxin tolerant grasses have tolerance conferred by an AAD12 gene. The combination of (a), (b), and a complementary herbicide or salt or ester thereof can be used in combination with herbicides that are selective for the grass being treated and which complement the suppressed or prevented seedhead production controlled by these compounds at the application rate employed.

By way of non-limiting illustration, examples of certain embodiments of the present disclosure are given below.

### EXAMPLES

### Evaluation of Aminocyclopyrachlor and Metsulfuron-Methyl for Prevention or Suppression of Seedhead Production

Field trials were conducted with applications made to established pastures having X fescue in a Kentucky blue grass mix. The target plants were treated with postemergence foliar applications when they were approximately 6-10 inches tall. All treatments were applied using a randomized complete block trial design, with four replications per treatment.

Treatments consisted of aminocyclopyrachlor in acid form and metsulfuron-methyl, each in water and applied alone or in combination. Spray solutions were prepared using an appropriate amount of dilution to form a 1 liter (L) aqueous spray solution with active ingredients in single and two-way combinations. Formulated compounds were applied to the plant material with a backpack sprayer equipped with 8003 flat fan nozzles calibrated to deliver 20 gallons per acre (gal/acre) or 187 liters per hectare (L/ha) at a spray height of 15 inches (38.1 centimeters (cm)) above the grass.

The treated plots and control plots were rated blind at various intervals after application. Ratings were based on a scale of 0-100%, as discussed above, wherein 0% indicates no prevention or suppression of seedhead production and 100% indicates complete prevention or suppression of seedhead production.

Colby's equation was used to determine the seedhead-suppressant effects expected from the mixtures, as described above. The results were measured at 12 days after the first application of the compositions. The trials exhibited unexpected synergy, and those results were found statistically significant under the p-value test. The herbicide tank mix combinations tested, application rates and ratios employed, plant species tested, and results are given below.

| | Aminocyclopyrachlor | | Metsulfuron-Methyl | | Combination | |
|---|---|---|---|---|---|---|
| Evaluation | | | | | Measured | Colby predicted |
| Interval | g | Mean % seedhead | | Mean % seedhead | mean % seedhead | mean % seedhead |
| (days) | ae/ha | suppression | g ae/ha | suppression | suppression | suppression |
| 12 days | 70 | 5.0 | 13 | 80.0 | 86.3 | 80.6 |

As shown above, the samples demonstrated synergistic weed control, with higher measured weed control than would be predicted by the Colby equation.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein; however, other combinations of steps, elements, components, and constituents are included, even though not explicitly stated. The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches.

What is claimed is:

1. A herbicidal composition comprising a synergistically effective amount to suppress grass seedhead production of (a) aminocyclopyrachlor, or an agriculturally acceptable salt or ester thereof and (b) metsulfuron, or an agriculturally acceptable salt or ester thereof.

2. The composition of claim 1, wherein (a) includes aminocyclopyrachlor in acid form.

3. The composition of claim 1, wherein (b) includes metsulfuron-methyl.

4. The composition of claim 1, wherein the acid equivalent weight ratio of (a) to (b) is from 4:1 to 8:1.

5. The composition of claim 1, further comprising an additional pesticide, wherein the additional pesticide includes one or more pesticides selected from the group consisting of 2,4-D, aminopyralid, amicarbazone, bromoxynil, chlorsulfuron, clopyralid, dicamba, dichlorprop-P, diclosulam, diuron, florasulam, flucarbazone-sodium, flumetsulam, fluoroxypyr, glyphosate, glufosinate, imazamox, imazapyr, imazapic, imazaquin, imazethapyr, imazamethabenz, indaziflam, ioxynil, MCPA, mecoprop-P, oxyfluorfen, penoxsulam, picloram, pinoxaden, pyroxsulam, rimsulfuron, sulfometuron, thifensulfuron-methyl, tebuthiuron, tribenuron-methyl, triclopyr, and agriculturally acceptable salts or esters or mixtures thereof.

6. The composition of claim 1, wherein the composition is provided as a herbicidal concentrate.

7. The composition of claim 1, wherein the grass is fescue.

8. A method of controlling grass seedhead production, which comprises applying to vegetation or an area adjacent the vegetation or applying to soil or water to prevent or suppress grass seedhead production (a) aminocyclopyrachlor, or an agriculturally acceptable salt or ester thereof and (b) metsulfuron, or an agriculturally acceptable salt or ester thereof,
wherein (a) and (b) are each added in an amount sufficient to produce a synergistic grass seedhead-suppressant effect.

9. The method of claim 8, wherein (a) and (b) are applied simultaneously.

10. The method of claim 8, wherein (a) and (b) are applied pre-seedhead emergence to the vegetation.

11. The method of claim 8, wherein (a) includes aminocyclopyrachlor in acid form.

12. The method of claim 8, wherein (b) includes metsulfuron-methyl.

13. The method of claim 8, further comprising applying an additional pesticide, wherein the additional pesticide includes one or more pesticides selected from the group consisting of 2,4-D, aminopyralid, amicarbazone, bromoxynil, chlorsulfuron, clopyralid, dicamba, dichlorprop-P, diclosulam, diuron, florasulam, flucarbazone-sodium, flumetsulam, fluoroxypyr, glyphosate, glufosinate, imazamox, imazapyr, imazapic, imazaquin, imazethapyr, imazamethabenz, indaziflam, ioxynil, MCPA, mecoprop-P, oxyfluorfen, penoxsulam, picloram, pinoxaden, pyroxsulam, rimsulfuron, sulfometuron, thifensulfuron-methyl, tebuthiuron, tribenuron-methyl, triclopyr, and agriculturally acceptable salts or esters.

14. The method of claim 8, wherein the grass seedhead production is controlled in pastures.

15. The method of claim 8, wherein the grass seedhead production is controlled in grasses tolerant to glyphosate, glufosinate, dicamba, phenoxy auxins, pyridyloxy auxins, aryloxyphenoxypropionates, acetyl CoA carboxylase (ACCase) inhibitors, imidazolinones, acetolactate synthase (ALS) inhibitors, 4-hydroxyphenyl-pyruvate dioxygenase (HPPD) inhibitors, protoporphyrinogen oxidase (PPO) inhibitors, triazines, bromoxynil, or combinations thereof.

16. The method of claim 15, wherein the grass seedhead production is controlled in phenoxy auxin tolerant grasses and the phenoxy auxin tolerant grasses have tolerance conferred by an AAD12 gene.

17. The method of claim 8, wherein the grass seedhead production is controlled in grasses that are resistant to auxinic herbicides.

18. The method of claim 8, wherein (a) is applied in an amount of from 5 g ae/ha to 280 g ae/ha.

19. The method of claim 8, wherein (b) is applied in an amount of from 5 g ae/ha to 88 g ae/ha.

20. The method of claim 8, wherein the grass is fescue.
